(19) United States
(12) Patent Application Publication
(10) Pub. No.: US 2020/0401907 A1
(43) Pub. Date: Dec. 24, 2020

(54) USING ARTIFICIAL INTELLIGENCE FOR ANALYSIS OF ENVIRONMENTAL CONDITIONS, CLOTHING OPTIONS, AND PERSONAL THERMAL COMFORT FOR INTELLIGENT CLOTHING OPTIONS

(71) Applicant: International Business Machines Corporation, Armonk, NY (US)

(72) Inventors: Stan Kevin Daley, Atlanta, GA (US); Craig M. Trim, Ventura, CA (US); Michael Bender, Rye Brook, NY (US); Jeremy R. Fox, Georgetown, TX (US)

(21) Appl. No.: 16/450,004

(22) Filed: Jun. 24, 2019

(51) Int. Cl. G06N 5/02; G06F 16/2455

(52) U.S. Cl. CPC G06N 5/02; G06F 16/2455

(57) ABSTRACT

A method, computer system, and computer program product for generating clothing suggestions for a user. In an embodiment, the method comprises capturing environmental information, using a computer system, for the user for one or more designated places during a time period; analyzing, using cognitive analysis using the computer system, specified thermal requirements of the user; generating, by the computer system, clothing suggestions for the user, based on the captured environmental information and the analyzed thermal requirements, for the one or more designated places during the time period; and communicating the clothing suggestions to the user. In embodiments, the generating clothing suggestions includes receiving clothing options for the user from a populated database of the user's clothing which is available for use; receiving an inventory of the clothing the user is wearing; and generating the clothing suggestions based on the clothing options and the clothing the user is wearing.

### BACKGROUND

This invention, generally, relates to using artificial intelligence to help a person select suitable clothing to wear. More specifically, embodiments of the invention relate to using artificial intelligence to help a person make this selection based on an analysis of environmental conditions, clothing options, and personal thermal comfort.

Many people forget to check what the weather is going to be and how they are spending their day when picking out what to wear. In addition, everyone has a different sensitivity to environmental conditions such as temperature, humidity and wind. This makes deciding the correct clothing to wear for all a person's daily activities difficult. And while there is always the approach of wearing layers of clothing, many individuals just do not wear layers.

### SUMMARY

Embodiments of the invention provide a method, system, and computer program product for generating clothing suggestions for a user. In an embodiment, the method comprises capturing environmental information, using a computer system, for one or more designated places during a designated time period; analyzing, using cognitive analysis using the computer system, specified thermal requirements of the user; generating, by the computer system, clothing suggestions for the user, based on the captured environmental information and the analyzed thermal requirements, for the user for the one or more designated places during the designated time period; and communicating the clothing suggestions to the user.

In embodiments, the generating clothing suggestions for the user includes receiving clothing options for the user from a populated database of the user's clothing which is available for use; receiving an inventory of the clothing the user is wearing; and generating the clothing suggestions based on the clothing options and the clothing the user is wearing.

In embodiments, the one or more designated places and the designated time period are obtained, by the computer system, from a specified schedule of the user.

In embodiments, the analyzing, using cognitive analysis using the computer system, specified thermal requirements of the user, includes a metabolic rate of the user, activities planned by the user, clothing insulation, air temperature, humidity, wind speed, and an anticipated amount of sunlight at the one or more designated places.

Embodiments of the invention provide an optimization of clothing selection for an individual based on cognitive analysis of specified influencers on thermal comfort.

Embodiments of the invention teach an individual how to dress for the dynamic conditions that the individual will be experiencing that day. The system analyzes what a person is wearing, where that person will be, what the person will be doing, the environmental conditions, and the person's reactions to the combinations based on what he or she is wearing. That information is used to build a knowledgebase for reviewing what the person should be wearing on a given day based on when that person was not experiencing thermal neutrality.

Embodiments of the invention provide a system and method to determine a mix of clothing for planned conditions and activities throughout the day, based on an analysis of previous responses to environmental and weather conditions and uniquely personalized activities. This is done by creating a learning loop, determining future conditions, capturing the clothing a person is wearing, and recommending a mix of clothing from available clothing that has an optimal mix based on future conditions and historical responses.

In embodiments, the learning loop is created by combining current weather conditions, current activities of the person, current clothing mix worn by the person, determining if the person is warm or cold, determining if the person adds or removes clothing during the day as conditions change, and determining if the person had a negative health response (e.g., sunburn) to the previous mix of clothing.

The future conditions are determined by combining forecasted weather, and calendar entries to know locations (e.g., conference room) and planned activities. This will also allow a person to know how they reacted in certain environmentally controlled areas (by looking at history). The clothing a person is wearing is captured by image analysis, and smart clothing communicating to the system. In embodiments of the invention, individuals can also link clothing they are willing to wear together, or not willing to wear together (e.g., do not mix stripes and polka dots). Based on registered items, embodiments of the invention find items that are interchangeable based on product (e.g., 100% cotton, weight of shirt).

In embodiments of the invention, the system can be initiated by a user asking for advice or by an Artificial Intelligence (AI) system determining that the person is not properly prepared for the day.

In embodiments, the system can look ahead more than one day and recommend purchasing additional clothing to meet the demands that a person may not be prepared for. This embodiment allows integration with online retailers.

Embodiments of the invention provide a system and method to cognitively learn the proper mix of clothing for an individual to be comfortable based on probable conditions and activities.

Embodiments of the invention provide a system and method for an AI system to cognitively analyze the clothing a person is currently wearing and proactively recommend changes based on the recommended mix.

In embodiments of the invention, the user provides consent for the collection and use of their data. In embodiments, the user decides to opt-in to capturing and analyzing their data by providing access to automated data feeds from IoT devices or manually entering the data into the system. In embodiments, the user gives consent to collect data, including but not limited to, calendar data, other activity entries, location data, historical data, personal preferences, clothing purchases, camera use, physiological metrics, and verbal and typed comments. In embodiment, the collected or obtained data are securely maintained; and the user can opt out at any time, and collected data about the user is securely disposed when the user opts out.

### BRIEF DESCRIPTION OF THE SEVERAL VIEWS OF THE DRAWINGS

FIG. 1 is a diagram illustrating a method and system in accordance with an embodiment of the invention.

FIG. 2 is a flowchart illustrating the operation of embodiments of the invention.

FIG. 3 shows a clothing selection system in accordance with an embodiment of the invention.

FIG. 4 is a block diagram of a computer system of the clothing selection system of FIG. 2.

FIG. 5 depicts a cloud computing node according to an embodiment of the present invention.

FIG. 6 depicts a cloud computing environment according to an embodiment of the present invention.

FIG. 7 depicts abstraction model layers according to an embodiment of the present invention.

### DETAILED DESCRIPTION

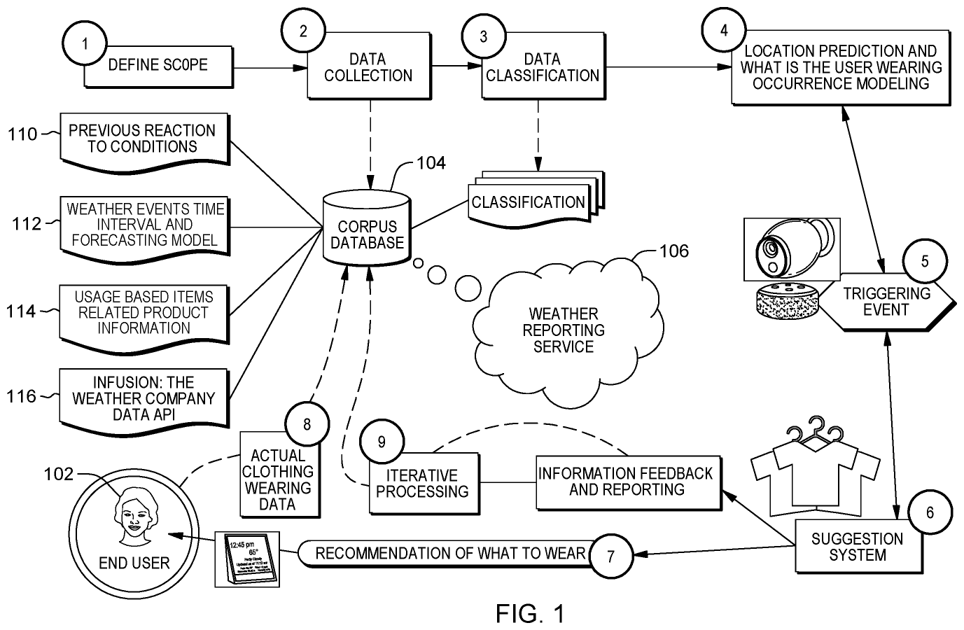

FIG. 1 diagrammatically illustrates a method and system in accordance with an embodiment of the invention. Generally, this embodiment comprises defining a scope 1, data collection 2, and data classification 3. The method predicts 4 a location for the user and predicts what the user will be wearing at the location. In response to a triggering event 5, the method determines 6 clothing suggestions for the user, and these suggestions are communicated 7 to the end user. The method obtains 8 actual clothing wearing data; and, in iterative processing, provides information feedback and reporting. FIG. 1 also shows an end user 102, a corpus database 104, and a weather reporting service 106.

Defining the scope comprises identifying the inputs and the relevant time frame for the method and system. Data classification comprises using machine learning to look for patterns. For example, the system may identify times when a person was cold or warm, and where the person was and what the person was wearing at those times. The Location Prediction and What is the User Wearing Occurrence Modeling determines where a person will be and the thermal impact at different times and determines what a person is currently wearing. This information is compared with the information that was classified at 3, and an answer is generated for what the person should wear.

A triggering event 5 occurs when the data classification 3 and the Location Prediction and the Modeling 4 together indicate a person will be too hot or too cold. When this happens, the suggestion system 6 generates a suggestion of what clothes the person should wear. This suggestion is output to the end user at 7. For example, the output may be spoken by a digital personal assistant. The clothing suggestion is also processed, in iterative processing 9, for feedback and reporting, and the result of the iterative processing is sent to database 104. Actual clothing wearing data 8 are also sent to database 104.

Data that are generated or collected are stored in the corpus database 104. These data may include, for instance, data 110 about previous reactions to conditions, data 112 about weather events, time intervals, and forecasting models. The stored data may also include data 114 about usage based items and related product information, and the stored data may include weather data 116, which may be infused from a weather company or reporting service 106 via an application program interface. Determining times when a person is not in a thermal comfort zone can be done by analyzing IoT device data (e.g., a camera captures a person sweating or smart clothing determines a person is sweating).

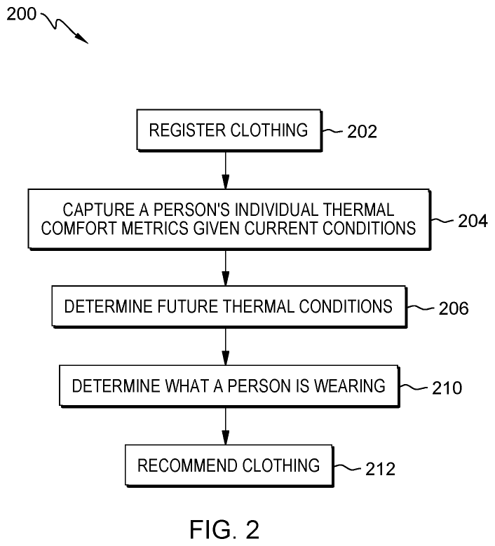

FIG. 2 is a flowchart 200 depicting an implementation of an embodiment of the invention. Embodiments of the invention provide a method 202 to register clothing, a method 204 to capture a person's individual thermal comfort metrics given current conditions, a method 206 to determine future thermal conditions, a method 210 to determine what a person is wearing, and a method 212 to recommend clothing.

The method 202 to register clothing teaches registering the clothing that an individual has. For each article of clothing, a picture may be taken of the clothing and sent to the system (or clothing may be registered from the manufacturer's SKU). The components of the clothing (e.g., 65% polyester, 35% cotton) are entered. The weight of the clothing is entered. The user also enters the type of clothing he or she considers the item to be (e.g., light jacket or shirt). For Internet of Things (IoT) enabled clothing, the clothing communications are registered.

The method 204 to capture a person's individual thermal comfort metrics given current conditions teaches capturing via IoT devices or a user interface if a person is comfortable and under what conditions. Thermal comfort data may include physiological based metrics as well as verbal or typed comments processed through Natural Language Processing (NLP). Current environmental conditions are captured via IoT sensors or system feeds (e.g., a weather channel). The clothing a person is currently wearing is captured via wearable technology, image analysis, IoT sensors, manual entry, or selection of previous recommendation from the system. Activities a person has/is engaged in are captured from sensors, calendars or manual entry. A person may enter a negative physical reaction to an event after the fact (e.g., sunburn, heat rash, frost bite).

The method 206 to determine future thermal conditions predicts the future conditions that an individual will experience. In embodiments of the invention, this includes ingesting calendar information to determine locations a person is scheduled to be at. Sub-locations, such as specific conference rooms or dining rooms, may be used when available. Repeatable activities (e.g., lunch) of a person are determined based on historical patterns and GPS location. In embodiments of the invention, this method also includes ingesting a weather forecast.

The method 210 to determine what a person is wearing uses camera feeds, data from smart clothing, and manual entry of data.

The method 212 to recommend clothing recommends a clothing mix for an individual. In embodiments of the invention, the recommendation is system initiated. The recommendation may be request based, or via an analysis that the current mix is not appropriate. The request can be to modify or fully replace current clothing based on an Artificial Intelligence (AI) system initiating the request. In embodiments of the invention, the system determines an appropriate clothing mix based on thermal characteristics of the clothing, based on historical reactions and predicted weather. The system reviews available inventory of clothing registered in the system. The system can then interface to an acceptable fashion mix for an individual. In embodiments of the invention, the system communicates with an individual the recommended changes. For example, a digital assistant may show combinations on a screen or talk to the individual. Messages/emails may be used to describe combinations. Intra-day recommendations may be used to tell a person to add/remove items.

Embodiments of the invention can be used in many specific cases.

As an example, on-line retailers now give fashion advice. Some retailers let a person upload two photos of themselves wearing two different outfits. Then, the person gets a verdict from a stylist, telling the person which look the person ought to go for. Embodiments of the invention work well with these types of retail use cases.

The on-line fashion industry is both mature and likewise burgeoning with web sites and apps that give style advice in an objective fashion. The ability to predict the type of clothes a person should wear works well in this embodiment.

As another example, a citizen has lost some of her cognitive skills and needs assistance in selecting clothing that is appropriate for the weather. In embodiments of the invention, the system knows she goes to church every Sunday; and when it is cold outdoors on Sunday, the system sees what she is wearing and recommends that she add another layer of clothing because she is always cold on the bus ride to church.

A man works in an open landscape office that is always cold. However, there is one conference room that is very hot. In embodiments of the invention, based on an analysis of his calendar, the system determines that this man has one meeting in the hot conference room. The system recommends that he add a light vest and take the vest off when he goes to the conference room. Prior to the meeting, he is reminded to take off the vest.

As a further example, a plumber is constantly going indoors and outdoors while going to different houses. In embodiments of the invention, the system has determined that he is hot in the houses and cold outside. The system has also learned that the man does not add or take off any clothing while working. The system recommends a sweat wicking shirt that he has which will absorb the sweat he has while working inside, but not let him get too cold from a wet shirt when outside.

Embodiments of the invention provide a number of important advantages. For instance, embodiments of the invention provide opportunities to advance the Personal Digital Assistant space through helping users make better planning decisions prior to any weather event or environmental planning for that user's calendar or events. Also, embodiments of the invention may be used for modeling data infusion for Weather And Personal Digital Assistants to give recommendations for clothing to people.

Embodiments of the invention may be used in Business-to-Consumer (B2C) Marketing. Embodiments may be used by businesses selling customers clothing based products specific to weather related events and someone's personal preferences, prior to the predicted events. For example, a user goes shopping on Sunday for clothing to buy for that week that would be suitable to the user's personal preferences based on temperatures for that week and geographically specific to where the user plans to be working (for a business traveler as an example).

In addition, embodiments of the invention add value to weather reporting data.

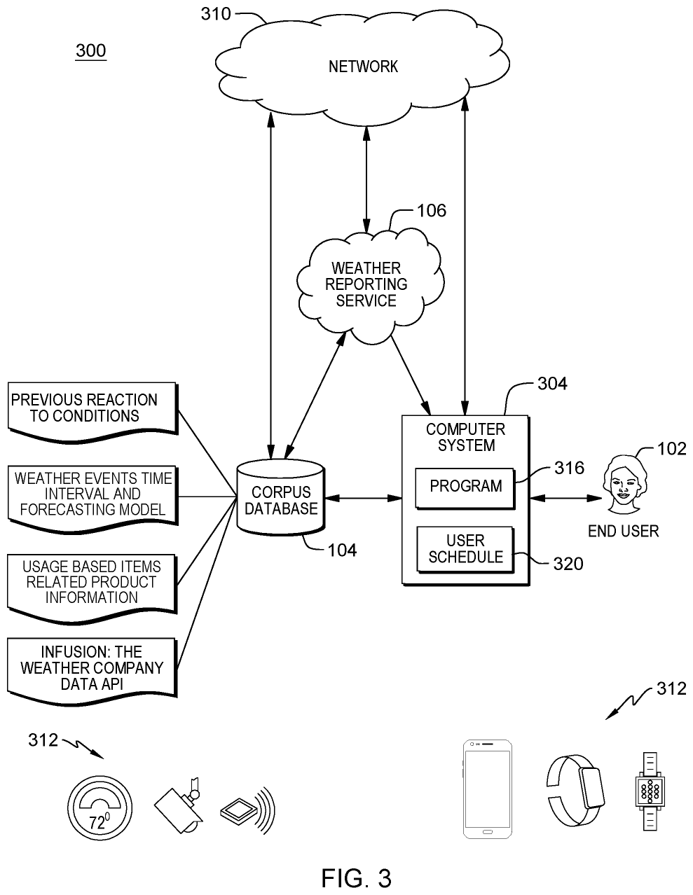

FIG. 3 illustrates a system 300 for providing intelligent clothing selection for an end user 302 in accordance with an embodiment of the invention. Generally, system 300 comprises computer system 304 and database 104. FIG. 3 also shows end user 102, a network 310 connected to computer system 304 and to database 104, weather reporting service 106, and a group of Internet of Things (IoT) devices 312.

In the example embodiment, network 310 may be the Internet, representing a worldwide collection of networks and gateways to support communications between devices connected to the Internet. Network 310 may include, for example, wired, wireless or fiber optic connections. In other embodiments, network 310 may be implemented as an intranet, a local area network (LAN), or a wide area network (WAN). In general, network 310 can be any combination of connections and protocols that will support communications to and from computer system 304.

Computer system 304 includes an intelligent clothing selection program 316 and the computer system may also include or have access to a user schedule or calendar 320.

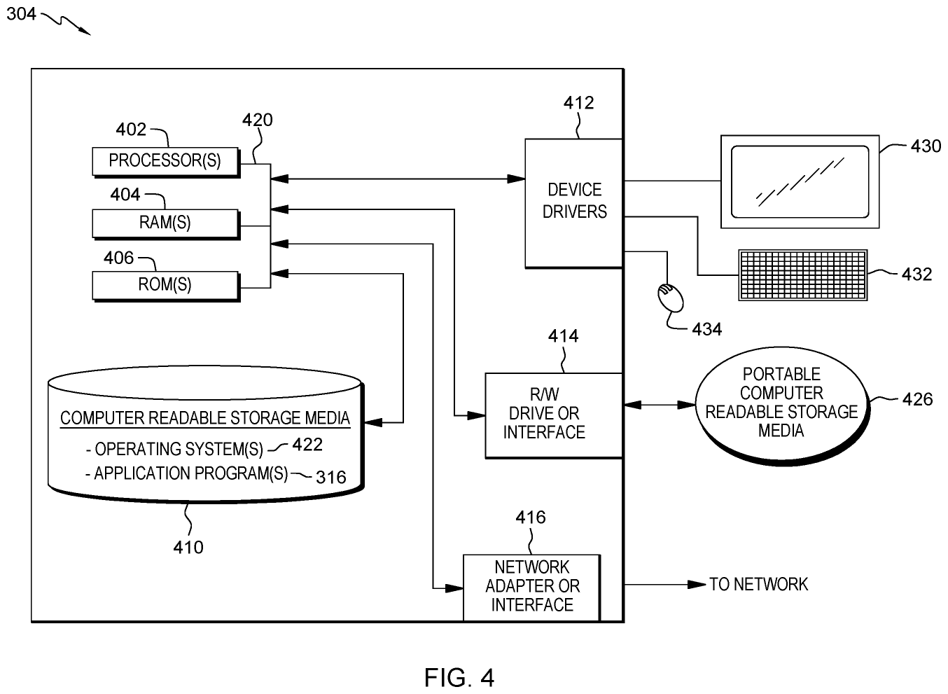

In the example embodiment, computer system 304 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. In addition, in the example embodiment, computer system is equipped with a camera (not shown). While computer system 304 is shown as a single device, in other embodiments, the computer system may be comprised of a cluster or plurality of computing devices, working together or working separately. Computing system 304 is described in more detail with reference to FIG. 4.

In an example embodiment, clothing and accessories of end user 102 are catalogued in an electronic database, such as database 104. Corpus database 104 is an organized collection of data. As discussed above, these data include data about previous reactions to conditions; data about weather events, time intervals, and forecasting models; data about usage based items and related product information; and data that may be infused from a weather company or reporting service.

In the example embodiment shown in FIG. 3, database 104 is separate from computer system 304. The database may be directly connected to computer system 304, or may be connected to the computer system via network 310. Alternatively, the database 306 is stored locally on the computer system 304.

Weather reporting service 106 is a source of information detailing weather conditions from all over the world. In the example embodiment, the weather reporting service is utilized by program 316 as a factor in determining which clothes are suitable for a particular day and location. Additionally, weather reporting service 106 is capable of accessing network 310 and is frequently updated to maintain the aforementioned information accurate.

User schedule 320 includes information detailing the schedule of the end user 102. In the example embodiment, user schedule 320 is input by the user via a user interface on computer system 304, however in other embodiments user schedule 320 may be imported work schedules or personal planners. User schedule 320 may include information such as departure times, arrival times, departure dates, arrival dates, and destinations corresponding to the user. Furthermore, in the example embodiment, user schedule 320 may include scheduled business and leisure trips. In the example embodiment, user schedule 320 can be received in advance and be repeated on a daily, weekly, monthly or yearly basis.

In the example embodiment, program 316 is a software application capable of analyzing user schedule 320, weather information from reporting service 106, and other information to determine which clothing and/or accessories to recommend to the end user for a particular day and occasion. Additionally, program 316 is further capable of transmitting information identifying selected clothing and/or accessories to the end user.

As an example, database 104 receives information about the end user's clothing and accessories by way of manual user entry through a user interface on computer system 304. In the example embodiment, the user may enter this information into database 104 through a user interface on computer system 304 by detailing clothing characteristics which may include brand, color, size, sleeve length, dress code, fabric/material, and a picture of the article. Also, database 104 may be populated by way of scanning universal product codes (UPCs) or by other means such as accessing purchase histories of the user. While in the example embodiment database 104 is stored remotely and accessed either via a direct connection or via a network, such as network 310, in other embodiments, database 104 may be stored locally on computer system 304.

In embodiments, program 316 analyzes user schedule 320 in order to determine the dress code and location of scheduled events. Program 316 scans user schedule 320 for keywords or other indicators to determine what dress code is appropriate for particular occasions. Keywords/indicators may be specified by user input or preloaded into program 316 and include words such as “work,” “gym,” “business,” “meeting,” “casual,” and the like. The user-specified or preloaded keywords are associated with dress codes, such as gym wear, streetwear, casual, business casual, smart casual, business/informal, and black tie/semi-formal, such that when detecting the presence of one or more of the keywords/indicators, program 316 can determine which dress code is appropriate for the particular occasion. These associations are either user input or preloaded into program 316. For example, the keyword “gym” would indicate a gym wear dress code while the keyword “meeting” would indicate a business/informal dress code.

Similarly, program 316 scans user schedule 320 to determine the scheduled destinations of the user in order to obtain the most relevant weather forecast. Program 316 scans for locational keywords/indicators that are user input or preloaded and may include addresses, buildings, cities, states, landmarks, and other location-specific indicators. Program 316 associates the location keywords/indicators with the corresponding locations in order to retrieve a weather forecast most relevant to the user. Furthermore, program 316 determines the duration of scheduled events such as business and leisure trips by scanning user schedule 320 for the start and end times of events along with hotel and travel accommodations. In embodiments, program 316 retrieves the relevant weather forecast from weather reporting service 106. The program 316 determines suitable attire based on user schedule and the relevant weather forecast.

IoT devices 312 are used to collect data. These devices, for instance, may be used to collect data about end user 102 and the clothes the end user is wearing, and these devices may be used to obtain data about a place where the end user is at or is expected to be at. IoT devices 312 may include a variety of devices that can communicate with other devices in network environment 300. Examples of IoT devices 312 include a location tag, an activity monitor, a thermostat, a monitoring camera, and a sensor device. Additional sensors such as pressure sensors, sound sensors or microphones and motion sensors may also be employed in network environment 300 to sense, monitor or record data or information. In embodiments of the invention, devices 312 may also listen to and be paged from other devices via network 310. Devices 312 typically have one or more specific functions to perform, such as measuring, monitoring, and/or reporting data.

In one implementation, devices 312 may connect to the network 310 to report data or request information. Devices, also, may input data directly to database 104 or computer system 304. Devices 312 may connect to network 310 in different ways, such as via a fixed Wi-Fi connection, a Bluetooth connection, a direct wireless network connection (e.g., a cellular connection using 3G, 4G or 5G standards), or a proprietary connection to a wireless network. While several specific network devices 312 are shown in FIG. 3, embodiments of the invention may use more, or fewer, IoT devices than are expressly shown in the Figure.

Those of ordinary skill in the art will appreciate that the architecture and hardware depicted in FIG. 3 may vary.

FIG. 4 depicts a block diagram of components of computer system 304 of FIG. 3, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Computer system 304 may include one or more processors 402, one or more computer-readable RAMs 404, one or more computer-readable ROMs 406, one or more computer readable storage media 410, device drivers 412, read/write drive or interface 414, network adapter or interface 416, all interconnected over a communications fabric 420. Communications fabric 420 may be implemented with any architecture designed for passing data and/or control information between processors (such as microprocessors, communications and network processors, etc.), system memory, peripheral devices, and any other hardware components within a system.

One or more operating systems 422, and one or more application programs, for example, program 316, are stored on one or more of the computer readable storage media 410 for execution by one or more of the processors 402 via one or more of the respective RAMs 404 (which typically include cache memory). In the illustrated embodiment, each of the computer readable storage media 410 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computer system 304 may also include a R/W drive or interface 414 to read from and write to one or more portable computer readable storage media 426. Application programs on computer system 304 may be stored on one or more of the portable computer readable storage media 426, read via the respective R/W drive or interface 414 and loaded into the respective computer readable storage media 408.

Computer system 304 may also include a network adapter or interface 416, such as a TCP/IP adapter card or wireless communication adapter (such as a 4G wireless communication adapter using OFDMA technology). Application programs 411 on computer system 304 may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 410. The network may comprise copper wires, optical fibers, wireless transmission, routers, firewalls, switches, gateway computers and/or edge servers.

Computer system 304 may also include a display screen 430, a keyboard or keypad 432, and a computer mouse or touchpad 424. Device drivers 412 interface to display screen 430 for imaging, to keyboard or keypad 422, to computer mouse or touchpad 434, and/or to display screen 420 for pressure sensing of alphanumeric character entry and user selections. The device drivers 412, R/W drive or interface 414 and network adapter or interface 416 may comprise hardware and software (stored on computer readable storage media 408 and/or ROM 406).

Embodiments of the invention are well suited for use with cloud computing which is a model of service delivery for enabling convenient, on-demand network access to a shared pool of configurable computing resources.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

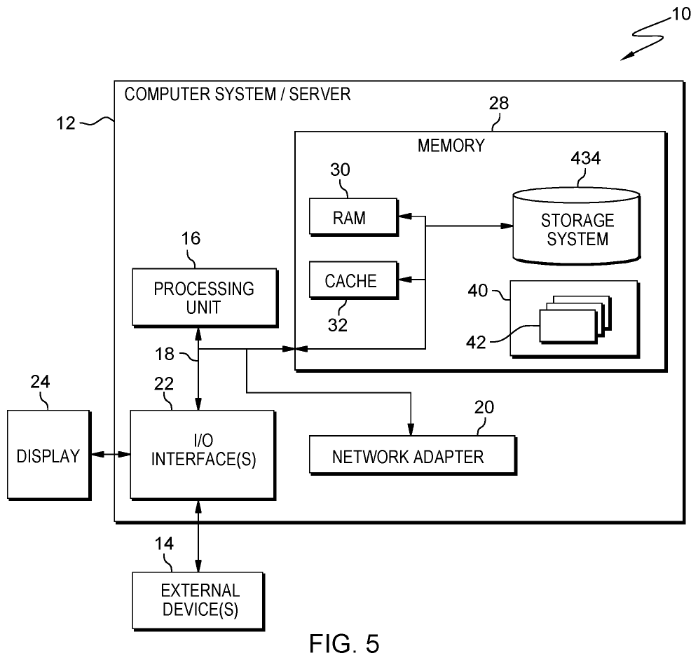

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

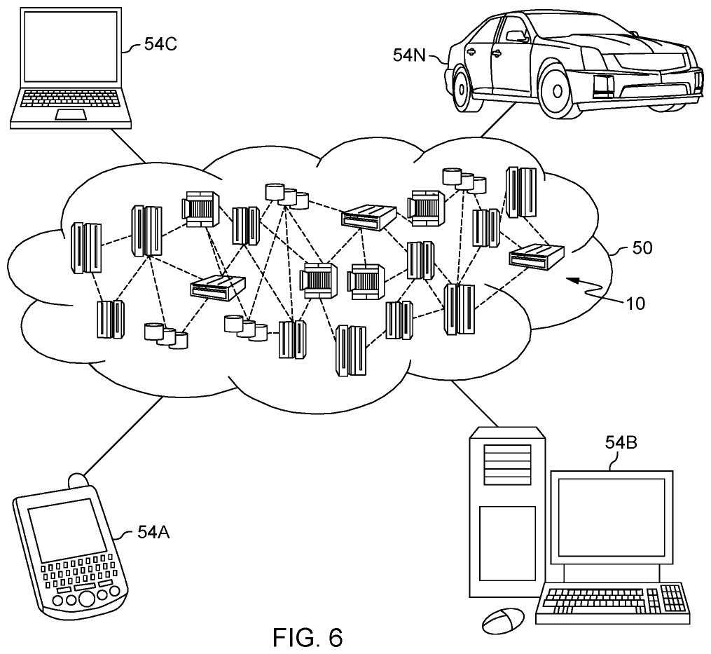

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

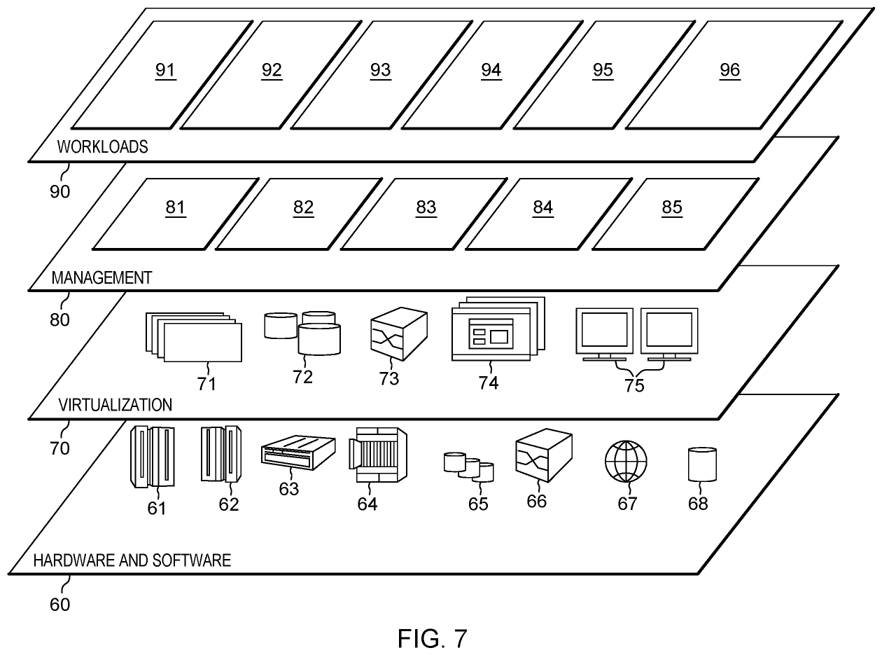

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing intelligent clothing options 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A method for generating clothing suggestions for a user, comprising:
capturing environmental information, using a computer system, for the user for one or more designated places during a designated time period;
analyzing, using cognitive analysis using the computer system, specified thermal requirements of the user;
generating, by the computer system, clothing suggestions for the user, based on the captured environmental information and the analyzed thermal requirements, for the user for one or more designated places during the designated time period; and
communicating the clothing suggestions to the user.

2. The method according to claim 1, wherein the generating clothing suggestions for the user includes:
receiving clothing options for the user from a populated database of the user's clothing which is available for use;
receiving an inventory of the clothing the user is wearing; and
generating the clothing suggestions based on the clothing options and the clothing the user is wearing.

3. The method according to claim 1, wherein the one or more designated places and the designated time period are obtained, by the computer system, from a specified schedule of the user.

4. The method according to claim 1, wherein the analyzing, using cognitive analysis using the computer system, specified thermal requirements of the user, includes a metabolic rate of the user, activities planned by the user, clothing insulation, and air temperature, humidity, wind speed, and an anticipated amount of sunlight at the one or more designated places.

5. The method according to claim 1, wherein the analyzing specified thermal requirements of the user includes:
identifying a defined thermal neutrality for the user; and
identifying historical data about the user when the user was experiencing the defined thermal neutrality.

6. The method according to claim 5, wherein the identifying historical data about the user when the user was experiencing the defined thermal neutrality includes identifying clothes the user was wearing when the user was experiencing the defined thermal neutrality.

7. The method according to claim 6, wherein the identifying historical data about the user when the user was experiencing the defined thermal neutrality further includes identifying activities and a metabolic rate of the user when the user was experiencing the defined thermal neutrality.

8. The method according to claim 5, wherein the generating clothing suggestions for the user includes identifying clothing for the user to experience the thermal neutrality at the one or more designated places during the designated time period.

9. The method according to claim 8, wherein the generating clothing suggestions for the user includes:
identifying expected activities of the user at the one or more designated places during the designated time period; and
selecting clothes for the user at the one or more designated places during the designated time period based on the identified expected activities of the user at the one or more designated places during the designated time period.

10. The method according to claim 9, wherein:
during the designated time period, the user is expected to change from one of the expected activities to another of the expected activities; and
the selecting clothes for the user at the one or more designated places during the designated time period further includes generating suggestions for the user to change clothing during said time period based on the change of the user from the one of the expected activities to the another of the expected activities.

11. A computer system for generating clothing suggestions for a user, comprising:
a memory; and
one or more processor unit connected to the memory;
said one or more processor units configured for:
capturing environmental information for the user for one or more designated places during a designated time period,
analyzing, using cognitive analysis, specified thermal requirements of the user,
generating clothing suggestions for the user, based on the captured environmental information and the analyzed thermal requirements, for one or more designated places during the designated time period, and
communicating the clothing suggestions to the user.

12. The computer system according to claim 11, wherein the generating clothing suggestions for the user includes:
receiving clothing options for the user from a populated database of the user's clothing which is available for use;
receiving an inventory of the clothing the user is wearing; and
generating the clothing suggestions based on the clothing options and the clothing the user is wearing.

13. The computer system according to claim 11, wherein the one or more designated places and the designated time period are obtained from a specified schedule of the user.

14. The computer system according to claim 11, wherein the analyzing, using cognitive analysis, specified thermal requirements of the user, includes a metabolic rate of the user, activities planned by the user, clothing insulation, and air temperature, humidity, wind speed, and an anticipated amount of sunlight at the one or more designated places.

15. The computer system according to claim 11, wherein the analyzing specified thermal requirements of the user includes:
identifying a defined thermal neutrality for the user; and
identifying historical data about the user when the user was experiencing the defined thermal neutrality, including
identifying clothes the user was wearing when the user was experiencing the defined thermal neutrality, and
identifying activities and a metabolic rate of the user when the user was experiencing the defined thermal neutrality.

16. A computer program product for generating clothing suggestions for a user, the computer program product comprising a computer readable storage medium having program instructions embodied therewith, the program instructions executable by a processor to cause the processor to:
capture environmental information for the user for one or more designated places during a designated time period,
analyze, using cognitive analysis, specified thermal requirements of the user,
generate clothing suggestions for the user, based on the captured environmental information and the analyzed thermal requirements, for one or more designated places during the designated time period, and
communicate the clothing suggestions to the user.

17. The computer program product according to claim 16, wherein the generate clothing suggestions for the user includes:
receiving clothing options for the user from a populated database of the user's clothing which is available for use;
receiving an inventory of the clothing the user is wearing; and
generating the clothing suggestions based on the clothing options and the clothing the user is wearing.

18. The computer program product according to claim 16, wherein the one or more designated places and the designated time period are obtained from a specified schedule of the user.

19. The computer program product according to claim 16, wherein the analyze, using cognitive analysis, specified thermal requirements of the user, includes a metabolic rate of the user, activities planned by the user, clothing insulation, and air temperature, humidity, wind speed, and an anticipated amount of sunlight at the one or more designated places.

20. The computer program product according to claim 16, wherein the analyze specified thermal requirements of the user includes:
identifying a defined thermal neutrality for the user; and
identifying historical data about the user when the user was experiencing the defined thermal neutrality, including
identifying clothes the user was wearing when the user was experiencing the defined thermal neutrality, and
identifying activities and a metabolic rate of the user when the user was experiencing the defined thermal neutrality.
